(19) United States
(12) Patent Application Publication
(10) Pub. No.: US 2015/0114222 A1
(43) Pub. Date: Apr. 30, 2015

(54) MICRO FLUID DEVICE AND METHOD OF SEPARATING AIR BUBBLES IN LIQUID

(71) Applicant: CANON KABUSHIKI KAISHA, Tokyo (JP)

(72) Inventor: Yoichi Murakami, Newport News, VA (US)

(21) Appl. No.: 14/520,697

(22) Filed: Oct. 22, 2014

(30) Foreign Application Priority Data
Oct. 25, 2013 (JP) 2013-222673

(51) Int. Cl. B01L 3/00; B01D 19/00

(52) U.S. Cl. CPC B01L 3/502723; B01D 19/0073; B01L 2200/0684; B01L 2300/0816; B01L 2300/0864; B01L 2200/10
USPC 95/31; 96/155; 95/241; 422/502

(57) ABSTRACT

A microfluidic device including: a substrate having a flow channel and an outlet port connected to the flow channel and configured to discharge liquid; and an inlet portion being present on a surface of the substrate and configured to allow injection of liquid into the flow channel, wherein
the inlet portion includes a first tube and a second tube being present in an interior of the first tube and having a height smaller than that of the first tube,
the outlet port includes a first outlet port and a second outlet port,
the flow channel includes a first flow channel and a second flow channel,
the second flow channel connects the second outlet port and a space between the first tube and the second tube, and
the first flow channel and the second flow channel are not connected.

### BACKGROUND

1. Field of the Invention

This disclosure relates to a microfluidic device and a method of separating air bubbles in liquid.

2. Description of the Related Art

In recent years, much research and development on a technology referred to as micro total analysis system (μ-Tas) in which all elements required for chemical and biochemical analyses are integrated on one chip is being made.

In the micro total analysis system as described above, a microfluidic device having an access tube used for injecting liquid is disclosed in U.S. Patent Application Publication No. 2011/0058519.

However, in the microfluidic device disclosed in U.S. Patent Application Publication No. 2011/0058519, a problem that control of liquid may be disabled due to entry of air bubbles in liquid into a flow channel of the microfluidic device may occur.

### SUMMARY OF THE INVENTION

This disclosure provides a microfluidic device including: a substrate having a flow channel and an outlet port connected to the flow channel and configured to discharge liquid; and an inlet portion being present on a surface of the substrate and configured to allow injection of liquid into the flow channel, wherein the inlet portion includes: a first tube; and a second tube being present in an interior of the first tube and having a height smaller than that of the first tube, the outlet port includes: a first outlet port; and a second outlet port, the flow channel includes: a first flow channel; and a second flow channel, the first flow channel connects the first outlet port and a space in an interior of the second tube, the second flow channel connects the second outlet port and a space between the first tube and the second tube, and the first flow channel and the second flow channel are not connected.

According to this disclosure, separation or reduction of air bubbles in liquid is achieved, and loss of control of liquid due to entry of air bubbles into the flow channel is restrained.

Further features of the present invention will become apparent from the following description of exemplary embodiments with reference to the attached drawings.

### BRIEF DESCRIPTION OF THE DRAWINGS

FIGS. 1A to 1C are conceptual drawings illustrating a microfluidic device of a first embodiment.

FIGS. 2A to 2E are drawings illustrating states of air bubbles at an inlet portion of the microfluidic device of the first embodiment.

FIGS. 3A to 3C are conceptual drawings illustrating an air bubble separation mechanism on the basis of air-liquid interface retention.

FIGS. 4A and 4B are cross-sectional views illustrating a microfluidic device of a second embodiment.

FIG. 5 is a conceptual drawing illustrating a microfluidic device of a comparative example.

FIGS. 6A to 6F are schematic drawings illustrating a liquid receipt and delivery process using an inlet portion of Example 2.

### DESCRIPTION OF THE EMBODIMENTS

Referring now to the drawings, embodiments of this disclosure will be described.

### First Embodiment

First embodiment provides a microfluidic device including: a substrate having a flow channel and an outlet port connected to the flow channel and configured to discharge liquid; and an inlet portion being present on a surface of the substrate and configured to allow injection of liquid into the flow channel, wherein the inlet portion includes: a first tube; and a second tube being present in the interior of the first tube and having a height smaller than that of the first tube, the outlet port includes: a first outlet port; and a second outlet port, the flow channel includes: a first flow channel; and a second flow channel, the first flow channel connects the first outlet port and a space in the interior of the second tube, the second flow channel connects the second outlet port and a space between the first tube and the second tube, the first flow channel and the second flow channel are not connected.

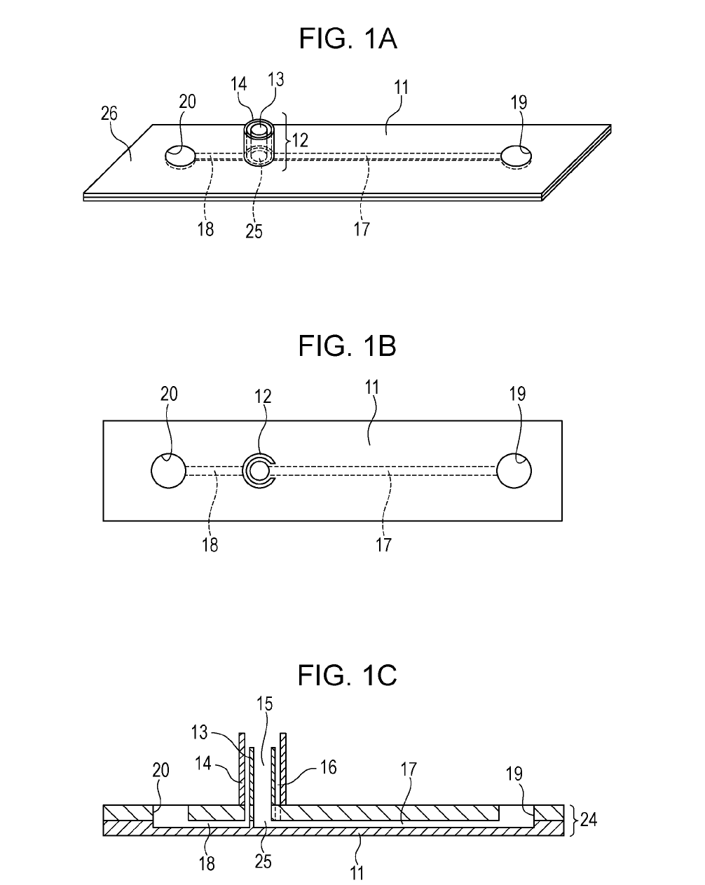

FIGS. 1A to 1C are conceptual drawings illustrating the microfluidic device of this embodiment. FIG. 1A is a schematic drawing of a microfluidic device of this embodiment, FIG. 1B is a top view, and FIG. 1C is a vertical cross-sectional side view.

A first tube 14 has an outer diameter of 700 μm, an inner diameter of 500 μm, and a length of 4.5 mm. A second tube 13 has an outer diameter of 300 μm, an inner diameter of 100 μm, and a length of 4 mm. A first outlet port 19 and a second outlet port 20 both have a diameter of 300 μm. As regards the flow channels, a first flow channel 17 has a length of 15 mm, and a second flow channel 18 has a length of 10 mm. Both of the first flow channel 17 and the second flow channel 18 have a cross-sectional area having a width of 100 μm and a depth of 50 μm. In this embodiment, the length and the diameter of the tube, the size of the outlet port, and the length and the size of the flow channel are set as described above. However, the microfluidic device of this disclosure is not limited thereto.

A microfluidic device 11 includes a substrate 24 having a flow channel and an outlet port connected to the flow channel and configured to discharge liquid, and an inlet portion 12 for introducing liquid to the flow channel.

The inlet portion 12 is present on a surface of the substrate 24, and includes the first tube 14 and the second tube 13 being present in an interior of the first tube 14. Since the second tube is present in an interior of the first tube, an inner diameter of the second tube is smaller than an inner diameter of the first tube. The height of the second tube 13 is lower than the height of the first tube 14. Preferably, the height of the second tube 13 is at least 10 μm higher than the height of the first tube 14. The term “the height of the tube” corresponds to a length of a perpendicular line drawn from an end of the tube on a side opposite to a main surface to a plane including a main surface 26 of the substrate. The term “tube” corresponds to a wall portion which constitutes part of the tube, and the term “main surface” of the substrate corresponds to a surface of the substrate to which the tube is connected.

Therefore, the expression “the height of the second tube 13 is higher than the height of the first tube 14” is equivalent to “the length of a perpendicular line drawn from an end of the second tube 13 on a side opposite to a main surface to a plane including the main surface 26 of the substrate 24 is shorter than the length of a perpendicular line drawn from an end of the first tube 14 on a side opposite to the main surface 26 to a plane including the main surface 26 of the substrate 24”. The first tube and the second tube need only to have a hollow cylindrical shape including, for example, a circular cylinder, an elliptic cylinder, or a polygonal cylinder.

The first tube 14 and the second tube 13 are preferably arranged so as to be perpendicular to the main surface 26 of the substrate 24. Arrangement in the perpendicular direction helps to prevent liquid from spilling out at the time of being received or delivered and from failing to be received or delivered.

The substrate 24 includes the first outlet port 19, the second outlet port 20, the first flow channel 17 configured to connect a space 15 in the interior of the second tube 13 and the first outlet port 19, and a second flow channel 18 configured to connect a space 16 between the first tube 14 and the second tube 13 and the second outlet port 20. The first flow channel 17 and the second flow channel 18 are not connected. In the following description, a connecting portion (reference numeral 25 in FIG. 1A) of the first flow channel 17 with respect to the inlet portion 12 may be referred to as an inlet port.

The first outlet port 19 and the second outlet port 20 are respectively coupled to pressure control mechanisms (not illustrated) via coupling portions with respect to the pressure control mechanisms such as tubes.

The material of the substrate 24 may be glass, ceramic, plastic, semiconductor, or hybrid thereof, but is not limited thereto.

The first flow channel 17 and the second flow channel 18 may be formed by performing a process such as etching, mechanical processing, or molding on a base material which becomes a base of formation of the substrate.

The first outlet port 19 and the second outlet port 20 may be formed by opening holes through the base material which is the base of formation of the substrate with a drill or the like. Since the first outlet port 19 and the second outlet port 20 are formed by opening holes with the drill or the like in many cases, these holes are formed into a circular shape in many cases. However, the size and the shape are not specifically limited.

The first tube 14 and the second tube 13 are preferably formed of a hydrophilic material. Since liquid to be injected into the microfluidic device generally have a hydrophilic property in many cases, hydrophilic liquid can be injected easily into the inlet portion by forming the first tube 14 and the second tube 13 of the hydrophilic material. Examples of such materials include silica.

The first tube 14 and the second tube 13 is preferably fixed to the substrate 24 with an UV-cured adhesive agent in terms of ease of operation. However, what is essential is just to ensure the fixation which does not allow the liquid to be injected from leaking, and the fixing method is not specifically limited. The first tube 14 and the second tube 13 may be formed of the same material as, or a different material from the substrate 24.

The first tube 14 and the second tube 13 may have a shape formed integrally with the substrate 24 from the beginning, that is, may have a shape having no seam between the first tube 14 and the substrate 24 and between the second tube 13 and the substrate 24. In such a case, the first tube 14 and the second tube 13 are formed of the same material as the substrate 24.

The liquid to be injected into the microfluidic device is test reagent or the like, and generally has a hydrophilic property as described above.

Subsequently, an example of methods of separating air bubbles in liquid using the microfluidic device of this embodiment will be described.

The method of separating air bubbles in liquid using the microfluidic device of this embodiment includes a process (A) including filling an interior of the microfluidic device with liquid a, bringing a liquid surface of the liquid a to be present between a distal end of the first tube and a distal end of the second tube, and gathering up air bubbles contained in the liquid a onto an inner peripheral surface of the first tube, and a process (B) including injecting liquid b in the inlet portion and, simultaneously, drawing the liquid a or the liquid a and the liquid b being present in the space in the interior of the second tube into the first flow channel, and drawing the liquid a or the liquid a and the liquid b being present in the space between the first tube and the second tube into the second flow channel.

With the method of separating air bubbles in liquid by using the microfluidic device of this embodiment, liquid is supplied to the inlet portion 12 having two tubes (the first tube 14 and the second tube 13) of the microfluidic device 11 by using a pipette, is separated into liquid containing air bubbles and liquid from which air bubbles are removed or reduced, and is fed to different outlet ports.

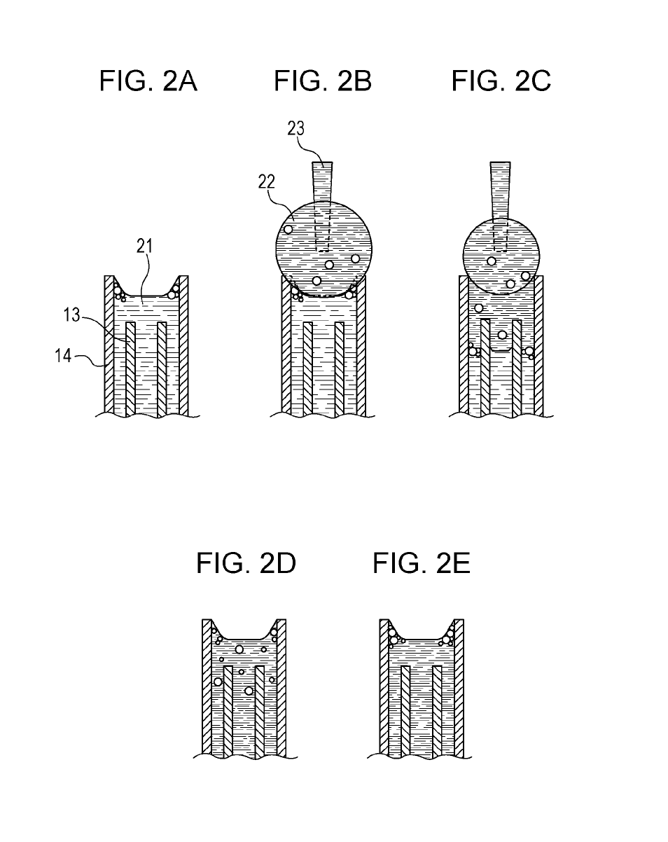

FIGS. 2A to 2E are enlarged drawings of the inlet portion 12 of the microfluidic device 11 of this embodiment, illustrating a liquid receipt and delivery process performed at the inlet portion 12 of the microfluidic device 11.

As illustrated in FIG. 2A, an interior of the microfluidic device 11 is filled with the liquid a an illustrated by reference numeral 21, and the liquid surface of the liquid a is held at a position higher than a distal end of the second tube 13, that is, the end of the second tube 13 on a side opposite to a main surface of the substrate (hereinafter, referred to also as a distal end) in the vicinity of the distal end of the first tube 14. In other words, the liquid surface of the liquid a is brought to and held to be present between the distal end of the first tube and the distal end of the second tube. At this time, air bubbles in the liquid a gather in an area in the vicinity of an inner peripheral portion of the first tube 14 after a certain period has elapsed as described later.

Filling of the microfluidic device 11 with the liquid a indicated by reference numeral 21 is achieved, for example, by loading the microfluidic device 11 in a deaeration container filled with the liquid a indicated by reference numeral 21, placing the first outlet port 19 and the second outlet port 20 below the liquid surface in the container in a standstill manner, deairing an interior of the container, so that the liquid a may be filled to the first flow channel 17, the second flow channel 18, and the inlet portion 12. At this time, air bubbles in the liquid a gather in the area in the vicinity of the distal end of the first tube 14 by a buoyancy force as described later.

Subsequently, as illustrated in FIG. 2B, the liquid b indicated by reference numeral 22 is pushed out from a distal end of a pipette 23 having the liquid b indicated by reference number 22 included therein so as to form a liquid drop, and is brought into contact with the liquid surface of the liquid a held in the vicinity of the distal end of the first tube 14. Here, a liquid drop supplying instrument that produces liquid drops of the liquid b is not limited to the pipette. The liquid a and the liquid b may be the same type of liquid and may be different types of liquid.

As illustrated in FIG. 2C, while maintaining a state in which a liquid drop 22 of the liquid b at the distal end of the pipette 23 is in contact with the liquid a in an interior of the inlet portion as in FIG. 2B, an interface between the liquid a indicated by reference numeral 21 and the liquid b indicated by reference numeral 22 in the space 15 in the interior of the second tube 13 and an interface between the liquid a indicated by reference numeral 21 and the liquid b indicated by reference numeral 22 in the space 16 between the first tube 14 and the second tube 13 are moved downward to a level below a main surface of the substrate at the substantially same lowering velocities with the pressure control mechanisms connected to the first outlet port 19 and the second outlet port 20 via tubes to discharge the liquid a or the liquid a and the liquid b containing air bubbles and gathering in the area in the vicinity of the inner peripheral surface of the first tube 14 from the second outlet port, and discharge the liquid a or liquid a and liquid b having less air bubbles in the vicinity of a center portion of the first tube from the first outlet port 19.

A state in which the liquid drop 22 is in contact with the inlet portion is maintained in FIGS. 2B and 2C. However, if the liquid a can be supplied so as not to lower an air-liquid interface to a position below the height of the second tube even though the liquid is drawn in FIG. 2C, the liquid drop 22 do not necessarily have to be maintained in contact with the inlet portion. When the liquid a and the liquid b are the same type of liquid, there is no interface therebetween. However, since there is an air bubble gathering area caused by air bubbles being present in the air-liquid interface of the liquid a at a portion where the liquid a and the liquid b come into contact with each other, the air bubble gathering area is referred to as an interface.

A center portion of the first tube described here means a portion in the vicinity of an intersection between a center axis of the first tube and the air-liquid interface. The center portion of the first tube corresponds to a range having a diameter of 50% of the inner diameter of the first tube centered at an intersection between the center axis of the first tube and the air-liquid interface. Furthermore, the area in the vicinity of the inner peripheral surface of the first tube corresponds to 50% the inner diameter of the first tube from the inner peripheral surface of the first tube.

Subsequently, as illustrated in FIG. 2D, the distal end of the pipette 23 which has been in contact with the liquid is separated to terminate the contact with the liquid, and then is held for a certain period of time. Accordingly, air bubbles being present in the interface between the liquid a and the liquid b reaches the air-liquid interface between the liquid b and the air by a buoyancy force. When the air bubble reaches the air-liquid interface, a buoyancy force of a component in a horizontal direction is applied to the air bubbles due to a meniscus shape of the air-liquid interface projecting downward, and hence the air bubbles move to a portion of the air-liquid interface in the vicinity of the inner peripheral surface of the first tube 14, so that the air bubbles in the liquid gather in the area in the vicinity of the inner peripheral surface of the first tube (FIG. 2E). In this case, movement of the air bubbles may be accelerated by applying physical energy to the air bubbles, for example, by a blast of air or an application of ultrasonic waves. Principle relating to the movement of air bubbles will be described later.

By repeating a set of actions illustrated in FIGS. 2A to 2E described above, air bubbles being present in the liquid a indicated by reference numeral 21 and gathering in the vicinity of the inner peripheral surface of the first tube pass through the space 16 between the first tube 14 and the second tube 13, are fed respectively to the second outlet port 20, and are removed. The liquid a having less air bubbles being present in the space in the interior of the second tube 13 is separated from liquid containing the air bubbles, passes the first flow channel 17, and is fed to the first outlet port 19. In other words, the liquid a is separated into the liquid containing air bubbles and the liquid from which air bubbles are removed, and these liquids can be fed to the different flow channels. Although the liquid a or the liquid a and the liquid b are discharged from the first outlet port and the second outlet port, if the liquid being present in the space in the interior of the second tube can be drawn into the first flow channel and the liquid being present in the space between the first tube and the second tube drawn into the second flow channel, air bubbles can be introduced into the second flow channel, and the liquid a or the liquid a and the liquid b do not have to be discharged to the first outlet port and the second outlet port.

In this manner, air bubbles are prevented from staying in the target flow channel and from disabling pressure control by feeding the liquid from which air bubbles are separated or removed to the flow channel.

Here, in FIG. 2E, a principle in which air bubbles are gathered in the area in the vicinity of the inner peripheral surface of the first tube by holding the air-liquid interface for a certain time will be described now.

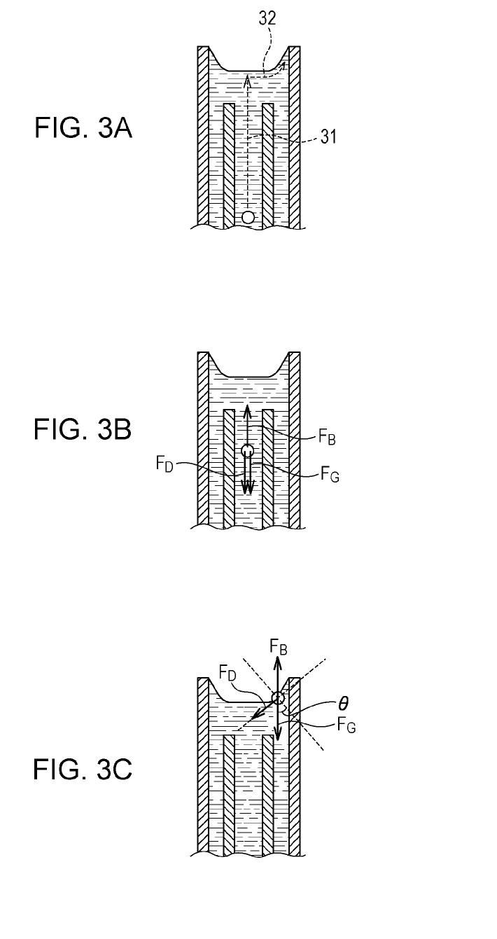

FIGS. 3A to 3C are conceptual drawing illustrating principle of the movement of an air bubble to the area in the vicinity of the inner peripheral surface of the first tube.

There are roughly two routes in which air bubbles pass when moving in the liquid in the inlet portion. FIG. 3A is a schematic drawing illustrating two courses of movement of an air bubble. A first course is a course 31 rising from a bottom of the inlet portion to the air-liquid interface (hereinafter, referred to also as a route 31). A second course is a course 32 (hereinafter referred to also as a route 32) moving along the air-liquid interface substantially in the horizontal direction. The bottom of the inlet portion described here corresponds to a coupling surface between the inlet portion and a main surface of the substrate, and indicates a boundary plane between a plane including a contact portion between the inlet portion and the main surface of the substrate and the inlet portion.

FIG. 3B is a schematic drawing illustrating forces generated in an air bubble in the route 31, and FIG. 3C is a schematic drawing illustrating forces generated in an air bubble in the route 32. An air bubble can be separated to the area in the vicinity of the inner peripheral surface of the first tube by holding the air-liquid interface for a time period more than a time period required for the air bubble to move along the route 31 and the route 32.

In the following description, methods of calculating the time periods required for the air bubble to move along the route 31 and the route 32 respectively will be described.

First of all, a time period required for the air bubble to move to the surface along the route 31 will be described. As illustrated in FIG. 3B, three forces, a buoyancy force F_{B}, a gravitational force F_{G}, and a drag F_{D} are generated in the air bubble while the air bubble moves from the bottom of the inlet portion to the air-liquid interface (curved liquid surface). The time period required for an air bubble to reach the air-liquid interface from the bottom of the inlet portion is estimated by establishing an equation of motion about the air bubble in fluid. The equation of motion of an air bubble in the fluid may be expressed as Expression 1 given below. At this time, the air bubble is considered to have a spherical shape having a radius r, and the buoyancy force, the gravitational force, and the drag applied to the air bubble are expressed as F_{B}, F_{G}, and F_{D} respectively, the volume, the density, the mass, and the velocity are expressed as V_{A}, ρ_{A}, M_{A}, and v respectively, and the viscosity and the density of water are expressed as μ and ρ_{w} respectively, and the gravitational acceleration is expressed as g.

$$m \frac{d v}{d t} = {F}_{B} - {F}_{G} - {F}_{D} \qquad ( 1 )$$

The buoyancy force F_{B} applied to an air bubble may be expressed as Expression 2 given below.

F_{B}=ρ_{W}V_{A}g (2)

The gravitational force F_{G} applied to an air bubble may be expressed as Expression 3 given below.

F_{G}=ρ_{A}V_{A}g (3)

The drag F_{D} (friction drag+pressure drag) around a spherical particle is expressed as Expression 4 on the basis of Stokes' expression.

F_{D}=6πμvr (4)

Here, it is assumed that a motion with acceleration is terminated immediately after a start of the motion of an air bubble and then a uniform motion starts, and that a state in which forces are balanced and the uniform motion has started. The velocity at this time is defined as a terminal velocity v_{f}. During the uniform motion, the gravitational force, the buoyancy force, and the drag are balanced, so that Expression 5 given below is established from Expression 1.

F_{B}−F_{G}−F_{D}=0 (5)

When substituting Expressions 2 to 4 into Expression 5 and organizing the result, the terminal velocity v_{f} is expressed as given below.

$${V}_{f} = \frac{2 g ( {ρ}_{A} - {ρ}_{W} ) {r}^{2}}{9 μ} \qquad ( 6 )$$

Subsequently, calculation of the time period taken when an air bubble moves along the route 32 in the horizontal direction, in other words, calculation of the time period required for an air bubble to move from a position in the vicinity of the center portion of the first tube, which is a position on the air-liquid interface where the air bubble has reached at the beginning to the area in the vicinity of the inner peripheral surface of the first tube will be described.

Likewise, the three forces, namely, the buoyancy force F_{B}, the gravitational force F_{G}, and the drag F_{D} are generated during the movement of an air bubble along the air-liquid interface after having reached the air-liquid interface as illustrated in FIG. 3C. Here, a buoyancy force decomposed in the horizontal direction acts on air bubbles reaching the air-liquid interface because the air-liquid interface has a meniscus shape depressed with respect to the horizontal direction, so that the air bubbles gather in the area in the vicinity of the inner peripheral surface of the first tube. A time period taken when an air bubble moves from a position on the air-liquid interface where the air bubble has reached at the beginning to the area in the vicinity of the inner peripheral surface of the first tube may also be estimated by establishing an equation of motion like Expression 1. Here, the horizontal direction is defined as an X-axis, a direction from the center axis toward an outer periphery of the first tube is defined as a positive direction, a vertical direction is defined as a Y-axis, and an angle formed between a normal line of a tangent line of the air-liquid interface and a Y-direction is defined as θ. When presuming that the value of θ is sufficiently small, the equation of motion of the air bubble on the air-liquid interface may be expressed as Expression 7.

$${M}_{A} \frac{{d}^{2} x}{d {t}^{2}} = {F}_{B} sin θ - {F}_{G} sin θ - {F}_{D} \qquad ( 7 )$$

Since the air-liquid interface is curved, if the radius of curvature at a center of the curve of the air-liquid interface is defined as R, if the value of θ is sufficiently small, Expression 8 is established.

$$θ = \frac{X}{R} \qquad ( 8 )$$

When substituting Expression 8 into Expression 7 and a differential equation is solved with t=0 and x=0, Expression 9 is established.

$$x = exp [ \frac{\{ - Cr + ( {C}^{2} {r}^{2} - 4 \sqrt{\frac{D}{R}} ) \} t}{2} ] \qquad ( 9 )$$

Here, C and D in Expression 9 are expressed as below.

$$C = \frac{6 πμ}{{ρ}_{A} {V}_{A}} , D = \frac{g ( {ρ}_{W} - {ρ}_{A} )}{{ρ}_{A}}$$

For example, when a diameter of an air bubble is 50 μm, a radius and a height of the first tube 14 are 250 μm and 4.5 mm respectively, air density is 1.29 (kg/m³), a density and a viscosity of liquid are 1000 (kg/m³) and 8.94×10⁻⁴ (Ns/m²) respectively, a time period required for the air bubble to reach the air-liquid interface from the bottom of the inlet portion, that is, a time period required for traveling the full distance of the route 31 is estimated to be 1.1 seconds from Expression 6. A time period for an air bubble to move along the air-liquid interface from a position on the air-liquid interface where the air bubble has reached at the beginning to the area in the vicinity of the inner peripheral surface of the first tube, that is, a time period required for traveling the full distance of the route 32 is estimated to be 0.3 second.

Therefore, the time period required for an air bubble to move from under liquid to the area in the vicinity of the inner peripheral surface of the first tube is estimated to be 1.4 seconds in total, and hence the air bubble can be separated to the position in the vicinity of the inner peripheral surface of the first tube by holding the air-liquid interface for 1.4 seconds.

### Second Embodiment

Subsequently, a microfluidic device of a second embodiment and a method of separating air bubbles in liquid by using the microfluidic device will be described.

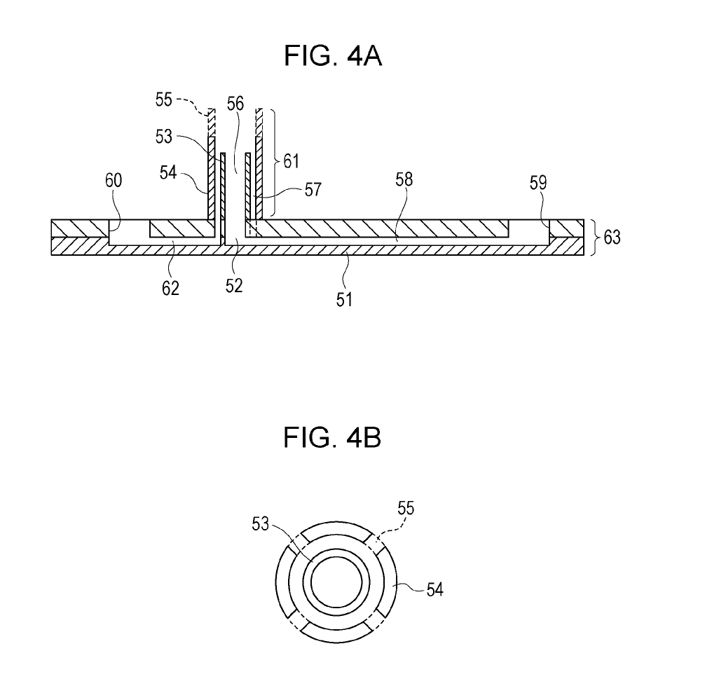

The microfluidic device of this embodiment includes apertures 55 formed so as to penetrate through a wall surface of a first tube 54 in a range from a distal end of the second tube to an end of the first tube on a side opposite to the main surface (that is, at positions higher than the height of a second tube 53) so as to penetrate from an inside to an outside of the first tube 54 as illustrated in FIGS. 4A and 4B. Since other configurations are the same as the microfluidic device of the first embodiment, description other than the first tube is omitted. FIG. 4A is a vertical cross-sectional side view illustrating the microfluidic device having apertures penetrating through the wall surface of the first tube from the inside to the outside thereof. FIG. 4B is an enlarged top view illustrating the inlet portion of the microfluidic device.

The apertures 55 of the first tube 54 may be and may not be connected to an end of the first tube 54 on a side opposite to a substrate 63. The shape of the apertures 55 may be any one of a circular shape, an ellipsoidal shape, a polygonal shape, a semi-circular shape, and a semi-ellipsoidal shape.

The number of the apertures 55 may either be one or more as long as being formed on an upper side with respect to a distal end (top) of the second tube 53. Since the first tube 54 includes the apertures 55, a small amount of liquid leaks from the apertures 55, so that a horizontal flow of liquid occurs. Accordingly, a movement of air bubbles in the horizontal direction in which the air bubbles move toward an area in the vicinity of an inner peripheral surface of the first tube 54 is accelerated. Consequently, the air bubbles gather in the area in the vicinity of the inner peripheral surface of the first tube 54 in a shorter time than in the microfluidic device of the first embodiment.

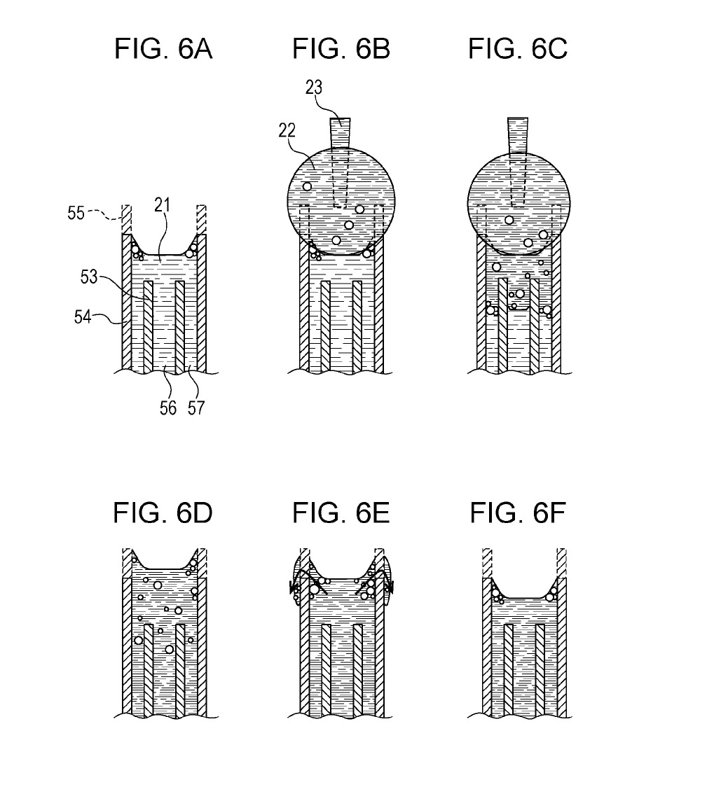

Subsequently, a liquid receipt and delivery process of this embodiment will be described with reference to FIGS. 4A and 4B and FIGS. 6A to 6F.

As illustrated in FIG. 6A, an interior of a microfluidic device 51 is filled with the liquid a indicated by reference numeral 21, and a liquid surface is held at a position higher than the distal end of the second tube 53.

Subsequently, as illustrated in FIG. 6B, in order to introduce the liquid b indicated by reference numeral 22 into a flow channel, the liquid b22 is pushed out from a distal end of the pipette so that the liquid b22 dispensed therefrom forms a spherical shape, and is brought into contact with the liquid surface held in the vicinity of the distal end of the first tube 54.

As illustrated in FIG. 6C, while maintaining a state in which the liquid b22 at the distal end of the pipette is in contact in FIG. 6B, interfaces between the liquid a21 and the liquid b22 in a space 56 in the interior of the second tube 53 and a space 57 between the first tube 54 and the second tube 53 are drawn to the bottom of the inlet portion at a substantially same lowering velocity by pressure control mechanisms connected to a first outlet port 59 and a second outlet port 60 in FIG. 4A. In this embodiment, the interface between the liquid a21 and the liquid b22 is drawn to the bottom of the inlet portion in the same manner as the first embodiment. However, the interfaces do not have to be drawn to the bottom of the inlet portion as long as liquid being present in the space in the interior of the second tube 53 can be drawn into a first flow channel 58 and liquid being present in a space between the first tube 54 and the second tube 53 can be drawn into a second flow channel 62.

As illustrated in FIG. 6D, the pipette is moved apart after having drawn. Right after that, a small amount of the liquid b indicated by reference sign 22 starts to leak from the apertures 55 as illustrated in FIG. 6E. Consequently, air bubbles gather in the area in the vicinity of the inner peripheral surface of the first tube 54 as illustrated in FIG. 6F.

By performing the above-described actions repeatedly on the liquid a21 and the liquid b22, liquid containing air bubbles may be discharged from the second outlet port 60 via the second flow channel 62 and liquid from which air bubbles are removed may be discharged from the first outlet port 59 via the first flow channel 58 in the same manner as the first embodiment.

In FIG. 6D, when the pipette is moved apart, a small amount of the liquid b indicated by reference numeral 22 leaks from the apertures 55, so that a horizontal flow of the liquid b occurs, and a movement of the air bubbles in the horizontal direction toward the area in the vicinity of the inner peripheral surface of the first tube 54 is accelerated. Accordingly, the air bubbles seem to gather in the area in the vicinity of the inner peripheral surface of the first tube 54 in a shorter time than the microfluidic device of the first embodiment.

### EXAMPLES

Subsequently, with reference to examples, this disclosure will be described in further detail. The following examples are intended to describe this disclosure in detail, and this disclosure is not limited by the following examples.

In the examples, a liquid receipt and delivery process is exemplified, and the fact that air bubbles are not clogged even though the receipt and delivery process is repeated, so that the liquid receipt and delivery process may be performed repeatedly without disabling pressure control. As a comparative example of this disclosure, an example in which the receipt and delivery process is performed with the microfluidic device by using a general inlet portion having only the first tube will be described. In the respective example, deionized water was used as the liquid a, and a reagent containing fluorescent dye Alexa fluor647 was used as the liquid b for facilitating an observation of the interface.

### Example 1

In Example 1, the microfluidic device 11 in which two tubes, namely, the first tube 14 being larger in diameter and length and the second tube 13 being smaller in diameter and length as illustrated in FIGS. 1A to 1C were arranged in the inlet portion 12 of the second tube 13 was formed and the liquid receipt and delivery process was performed.

The substrate 24 was formed by using two pieces of PMMA base material.

A first base material having an inlet port 25, the first outlet port 19, and the second outlet port 20 as illustrated in FIG. 1A and a second base material having the first flow channel 17 and the second flow channel 18 formed by molding were bonded each other with a UV cured adhesive agent to form the substrate 24. The shape of the hole of the inlet portion was formed by machining. In contrast, the first outlet port 19 and the second outlet port 20 were formed by using a drill. The inlet portion 12 included two silica tubes (hollow tubes) having different diameter and the length as the first tube 14 and the second tube 13. The first tube 14 and the second tube 13 were arranged perpendicularly with respect to the substrate 24, and were fixed with a UV cured adhesive agent, whereby the microfluidic device 11 was obtained. The first tube 14 being larger in diameter and length had an inner diameter of 500 μm and a length of 4.5 mm. The second tube 13 being smaller in diameter and length had an inner diameter of 100 μm and a length of 4 mm.

First of all, the interior of the microfluidic device 11 was filled with the liquid an indicated by reference numeral 21, and was placed at a position higher than the top of the second tube 13 to hold a liquid surface. Subsequently, the liquid b indicated by reference numeral 22 was pushed out from a distal end of the pipette so that liquid dispensed therefrom formed a spherical shape, and was brought into contact with the liquid surface held in the vicinity of the top of the first tube 14. While maintaining a state in which the liquid b22 at the distal end of the pipette was in contact, interfaces between the liquid 21 and the liquid 22 in the space 15 in the interior of the second tube 13 and the space 16 between the first tube 14 and the second tube 13 were drawn to the bottom of the inlet portion at a substantially same lowering velocity (0.1 mm/sec) by pressure control mechanisms installed at the first outlet port 19 and the second outlet port 20 via tubes. The pipette was moved apart after having drawn, and was held for two seconds. The liquid receipt and delivery process was performed by performing the actions as described above repeatedly on the liquid a21 and the liquid b22. Consequently, no clogging of the air bubbles was observed in the first flow channel 17 even after the receipt and delivery process had been performed 20 times, and the liquid could be drawn smoothly.

### Example 2

In Example 2, the microfluidic device 51 in which two tubes, namely the first tube 54 being larger in diameter and length and having the apertures 55 at the distal end thereof and the second tube 53 being smaller in diameter and length as illustrated in FIG. 4 were arranged in an inlet portion 61 was formed and the liquid receipt and delivery process was performed.

Manufacture of the microfluidic device 51 was performed in the same method as in Example 1 except that the apertures were formed in the first tube. The second tube 53 installed in the inlet portion 61 was the same that in Example 1. However, the first tube 54 was a cylinder having a length of 5 mm, which was larger than that of Example 1. As the apertures 55 penetrating through the first tube 54 from the inside to the outside of the wall surface of the tube were formed by forming four notches having a width of approximately 300 μm and a length of 500 μm at positions higher than the height of the second tube by laser beam machining.

First of all, the interior of the microfluidic device 51 was filled with the liquid an indicated by reference sign 21, and the liquid surface was held at a position higher than the top of the second tube 53. Subsequently, the liquid b indicated by reference numeral 22 was pushed out from a distal end of the pipette so that liquid dispensed therefrom formed a spherical shape, and was brought into contact with the liquid surface held in the vicinity of the top of the first tube 54. While maintaining a state in which the liquid b22 at the distal end of the pipette was in contact, interfaces between the liquid 21 and the liquid 22 in the space 56 in the interior of the second tube 53 and a space 57 between the first tube 54 and the second tube 53 were drawn to the bottom of the inlet portion at a substantially same lowering velocity (0.1 mm/sec) by pressure control mechanisms installed via tubes at the first outlet port 59 and the second outlet port 60. Subsequently, the pipette was moved apart, and was held for two seconds. At this time, since a small amount of the liquid b22 leaked from the apertures 55, a horizontal flow of the liquid b toward the area in the vicinity of the inner peripheral surface of the first tube 54 occurred, and a movement of air bubbles in the horizontal direction was accelerated. Consequently, the air bubbles gathered in the area in the vicinity of the inner peripheral surface of the first tube 54 in a shorter time than the microfluidic device of Example 1. The liquid receipt and delivery process was performed by performing the actions as described above repeatedly on the liquid a21 and the liquid b22. Consequently, no clogging of the air bubbles was observed in the first flow channel 58 even after the liquid receipt and delivery process had been performed 20 times, and the liquid could be drawn smoothly.

### Example 3

In Example 3, physical energy was applied to the air-liquid interface while the air-liquid interface of the liquid is held. In this example, the microfluidic device 11, which is the same as in Example 1, was used and a fan (not illustrated) was installed right above the inlet portion 12 as a blowing mechanism.

The liquid receipt and delivery process was the same as in Example 1 except for a process of holding the air-liquid interface. While a liquid surface of the liquid 22 was held, an air was fed from the fan installed right above the inlet portion 12. Accordingly, it was confirmed that a horizontal movement of air bubbles toward the area in the vicinity of the inner peripheral surface of the first tube 14 was accelerated because a flow of the liquid 22 from the position of the center axis of the first tube 14 toward the area in the vicinity of the inner peripheral surface of the first tube 14 was generated, and hence the air bubbles gathered in a shorter time than in Example 1. The liquid receipt and delivery process was performed on the liquid 21 and the liquid 22 by performing the actions as described above repeatedly. Consequently, the liquid could be drawn smoothly even after the liquid had been received and delivered 20 times.

### Comparative Example

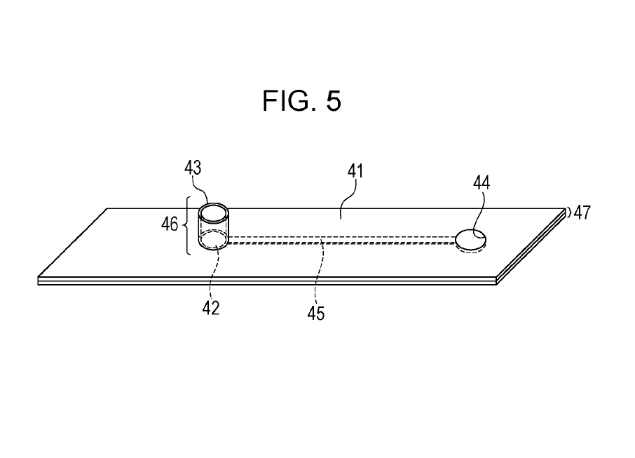

As a comparative example, a microfluidic device having only the first tube was manufactured and the liquid receipt and delivery process was performed. FIG. 5 is a conceptual drawing illustrating the microfluidic device having only the first tube.

A microfluidic device 41 was formed by using two pieces of PMMA base material. The microfluidic device was manufactured by bonding a first base material having an inlet port 42 and an outlet port 44 and a second base material having a flow channel formed by molding with a UV-cured adhesive agent. As an inlet portion 46, a silica tube as a first tube 43 was installed perpendicularly with respect to a substrate 47 and was fixed with the UV-cured adhesive agent. The first tube 43 having an inner diameter of 500 μm and a length of 4.5 mm was used.

First of all, the interior of the microfluidic device 41 was filled with the liquid 21, and a liquid surface was held on the top of the first tube 43. Subsequently, the liquid 22 was pushed out from the distal end of the pipette so that liquid dispensed therefrom formed a spherical shape, and was brought into contact with the liquid surface held at the top of the first tube 43. In a state in which the liquid 22 at the distal end of the pipette is in contact, the liquid 21 was drawn to a lower portion of the first tube 43 by a pressure control mechanism connected to the outlet port 44 via a tube. Subsequently, the pipette was moved apart, and was held for two seconds. The reagent receipt and delivery process was performed by repeatedly performing the actions as described above on the liquid 21 and the liquid 22. Consequently, clogging of air bubbles was observed in a flow channel 45 after the liquid had been received and delivered from pipette five times, and the liquid could not be drawn any longer even though a negative pressure was applied by the pressure control mechanism.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-222673, filed Oct. 25, 2013 which is hereby incorporated by reference herein in its entirety.

What is claimed is:

1. A microfluidic device comprising: a substrate having a flow channel and an outlet port connected to the flow channel and configured to discharge liquid; and an inlet portion on a surface of the substrate and configured to allow injection of liquid into the flow channel, wherein
the inlet portion includes a first tube and a second tube in the interior of the first tube and having a height smaller than that of the first tube,
the outlet port includes a first outlet port and a second outlet port,
the flow channel includes a first flow channel and a second flow channel,
the first flow channel connects the first outlet port and a space in the interior of the second tube, the second flow channel connects the second outlet port and a space between the first tube and the second tube, and
the first flow channel and the second flow channel are not connected.

2. The microfluidic device according to claim 1, wherein the first tube and the second tube are arranged perpendicularly with respect to a main surface of the substrate.

3. The microfluidic device according to claim 1, wherein a height of the first tube is at least 10 μm greater than a height of the second tube.

4. The microfluidic device according to claim 1, wherein the height of the tube corresponds to a length of a perpendicular line extending from an end of the tube on a side opposite to the main surface to a plane including the main surface of the substrate.

5. The microfluidic device according to claim 1, wherein the substrate and the inlet portion are formed of different materials.

6. The microfluidic device according to claim 1, wherein the first tube includes an aperture in a wall surface thereof in a range from a distal end of the second tube to an end of the first tube on a side opposite to the main surface.

7. A method of separating air bubbles in liquid comprising:
a process (A) including filling an interior of the microfluidic device according to claim 1 with liquid a, bringing a liquid surface of the liquid a to be present between a distal end of the first tube and a distal end of the second tube, and gathering up air bubbles contained in the liquid a onto an inner peripheral surface of the first tube, and
a process (B) including injecting liquid b in the inlet portion and, simultaneously, drawing the liquid a or the liquid a and the liquid b being present in a space in an interior of the second tube into the first flow channel, and drawing the liquid a or the liquid a and the liquid b being present in the space between the first tube and the second tube into the second flow channel.

8. The method of separating air bubbles in liquid according to claim 7, wherein the process (A) is performed by bringing the liquid surface of the liquid a to be present between the distal end of the first tube and the distal end of the second tube, and holding for a certain period.

9. The method of separating air bubbles in liquid according to claim 7, wherein the process (B) including injecting the liquid b in the inlet portion and, simultaneously, discharging the liquid a or the liquid a and the liquid b being present in the space in the interior of the second tube from the first outlet port, and discharging the liquid a or the liquid a and the liquid b being present in the space between the first tube and the second tube from the second outlet port.

10. The method of separating air bubbles in liquid according to claim 7, wherein the process (A) and the process (B) are repeated as one set.

11. The method of separating air bubbles in liquid according to claim 7, wherein physical energy is applied to an air-liquid interface of the liquid a.

12. The method of separating air bubbles in liquid according to claim 11, wherein the application of the physical energy includes a blast of gas and an application of ultrasonic waves.

13. The method of separating air bubbles in liquid according to claim 7, wherein the liquid a and the liquid b are the same type of liquid.
